(19) United States
(12) Patent Application Publication
(10) Pub. No.: US 2018/0337922 A1
(43) Pub. Date: Nov. 22, 2018

(54) METHOD AND DEVICE FOR CONTROLLING SMART DEVICE, SERVER AND STORAGE MEDIUM

(71) Applicant: BEIJING BAIDU NETCOM SCIENCE AND TECHNOLOGY CO., LTD., Beijing (CN)

(72) Inventor: Dachun LIAO, Beijing (CN)

(21) Appl. No.: 15/923,760

(22) Filed: Mar. 16, 2018

(30) Foreign Application Priority Data
May 22, 2017 (CN) 201710364315.8

(51) Int. Cl. H04L 29/06; G06F 21/44

(52) U.S. Cl. CPC H04L 63/0884; H04L 63/083; G06F 21/44

(57) ABSTRACT

Embodiments of the present disclosure disclose a method and a device for controlling a smart device, a server and a storage medium. The method includes: receiving a third-party login request from a client, in which the third-party login request includes a third-party identifier; obtaining a proprietary account bound with the third-party identifier, and sending the proprietary account to the client; and sending a control instruction to the smart device according to the proprietary account in response to a request carrying the proprietary account for controlling the smart device sent by the client.

### CROSS-REFERENCE TO RELATED APPLICATION

This application is based on and claims priority to Chinese Patent Application Serial No. 201710364315.8, filed on May 22, 2017, the entire content of which is incorporated herein by reference.

### FIELD

Embodiments of the present disclosure relate to a computer technology field, and more particularly to a method and a device for controlling a smart device, a server and a storage medium.

### BACKGROUND

Smart device is a technology concept behind smart phone. A conventional device may be transformed through a combination of hardware and software, so that it has intelligent functions. Therefore, the device has an ability to connect, loads Internet services, forms a typical architecture of “cloud+terminal”, and has additional values such as big data.

The smart device needs an own account when accessing to various cloud services. Different from apps (applications) in a common mobile phone, the smart device has a particular requirement about the account. For example, the smart device needs an independent account; the smart device needs to login silently when using the account; the smart device does not have a SIM (Subscriber Identity Module) and cannot login using an authentication message commonly used on the mobile apps; the smart device and a paired mobile app need to meet a many-to-many relationship; the account of the smart device has higher security requirements, and the like.

Generally, a user is paired with the smart device by logging on the client. After the user is successfully paired with the smart device, the user can control the smart device. However, in the related art, only a proprietary account system of the device manufacturer can be supported. That is, when the user wants to log on the client, the user has to register an account in the account system of the device manufacturer before the user can log on, thus causing a high usage threshold.

### SUMMARY

According to a first aspect of embodiments of the present disclosure, a method for controlling a smart device is provided. The method includes: receiving a third-party login request from a client, in which the third-party login request includes a third-party identifier; obtaining a proprietary account bound with the third-party identifier, and sending the proprietary account to the client; and sending a control instruction to the smart device according to the proprietary account in response to a request carrying the proprietary account for controlling the smart device sent by the client.

According to a second aspect of embodiments of the present disclosure, a server is provided. The server includes: one or more processors; a storage device, configured to store one or more programs. When the one or more programs are executed by the one or more processors, the one or more processors are caused to perform the above-mentioned method for controlling a smart device.

According to a third aspect of embodiments of the present disclosure, a computer readable storage medium is provided. The computer readable storage medium stores computer programs thereon. When the computer programs are executed by a processor, the above-mentioned method for controlling a smart device is performed.

### BRIEF DESCRIPTION OF THE DRAWINGS

FIG. 1 is a flow chart of a method for controlling a smart device according to an embodiment of the present disclosure:

FIG. 2 is a flow chart of a method for controlling a smart device according to an embodiment of the present disclosure;

FIG. 3 is a block diagram illustrating a device for controlling a smart device according to an embodiment of the present disclosure;

FIG. 4 is a block diagram illustrating a device for controlling a smart device according to an embodiment of the present disclosure;

FIG. 5 is a schematic diagram illustrating a server according to an embodiment of the present disclosure.

### DETAILED DESCRIPTION

Reference will be made in detail to the present disclosure with the accompanying drawings and embodiments. It should be understood that, the specific embodiments described herein are only used to explain the present disclosure and rather than to limit the present disclosure. In addition, it should be noted that, for the convenience of description, only some but not all structures related to the present disclosure are illustrated in the accompanying drawings.

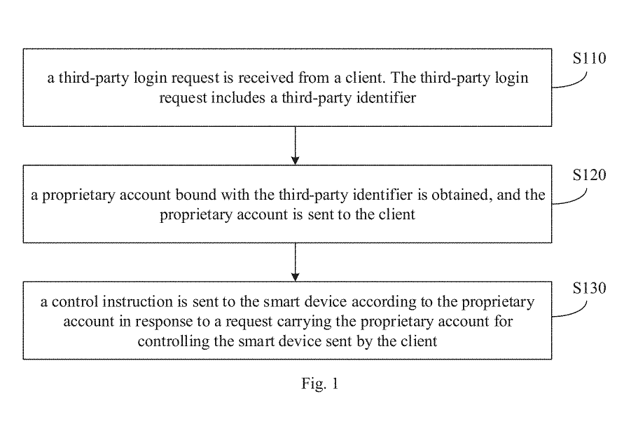

FIG. 1 is a flow chart of a method for controlling a smart device according to an embodiment of the present disclosure. The present embodiment may be applied in a case of accessing and controlling the smart device by third-party login. The method may be performed by a device for controlling the smart device. The device for controlling the smart device may be implemented in software and/or hardware, which may be generally integrated in a smart device server. The method for controlling the smart device according to the embodiment may include follows.

At block S110, a third-party login request is received from a client. The third-party login request includes a third-party identifier.

The client described herein refers to a supporting terminal of the smart device. For example, the client may be an intelligent terminal such as a mobile phone and the like. A user can be paired with the smart device through the client and the smart device server to establish a connection for accessing or controlling the smart device.

The third-party login request is initiated by the user through the client to the smart device server, intending to access or control the smart device through third-party login. For example, the third-party login may be Wechat login, QQ login, MicroBlog login, or the like. Correspondingly, the third-party identifier may be a Wechat account, a QQ account, a MicroBlog account, or the like.

In detail, after the user initiate the third-party login in the client, the client may first jump to a login interface of the third-party. Correspondingly, a third-party server may first receive information necessary for the third-party login sent from the client, such as user name, password, and the like. The third-party server verifies the information necessary for the third-party login, and if the information necessary for the third-party login is successfully verified, the third-party server returns the third-party identifier to the client. And then, the client sends the third-party login request containing the third-party identifier to the smart device server. That is, the third-party identifier is a successfully verified third-party identifier returned to the client by the third-party server before the smart device server receives the third-party login request sent from the client.

At block S120, a proprietary account bound with the third-party identifier is obtained, and the proprietary account is sent to the client.

After the smart device server receives the third-party login request, the smart device server obtains the third-party identifier from the third-party login request. And then, the smart device server may obtain the proprietary account bound with the third-party identifier by inquiring a database. The proprietary account belongs to a proprietary account system of the smart device. The smart device server returns the proprietary account to the client. Thus a relationship between the proprietary account and the third-party identifier is established. The third-party identifier is transformed to the proprietary account, completing the third-party login.

At block S130, a control instruction is sent to the smart device according to the proprietary account in response to a request carrying the proprietary account for controlling the smart device sent by the client.

After the third-party login, when the user controls the smart device via the client, a request for controlling the smart device may carry the proprietary account rather than an identifier or an account of the third-party login. The smart device server may recognize the proprietary account, and the smart device server sends the control instruction to the smart device according to the proprietary account and management mechanism of the proprietary account system.

It should be noted that, in embodiments of the present disclosure, the user may conveniently logs on the server by using various third-party accounts on the client so as to access the smart device. The smart device is not necessary to sense existence of the third-party account. The access and control to the smart device are performed based on the proprietary account after the user logs in with the third-party login. Therefore, user data of the smart device may not be leaked to the third-party, ensuring safety of the user data.

With embodiments of the present disclosure, when the client initiates the third-party login request, the proprietary account bound with the third-party identifier containing in the third-party login request is returned to the client. When the client initiates the request for controlling the smart device, the request for controlling the smart device may carry the proprietary account, such that the smart device server may complete the control to the smart device through the client according to the proprietary account. Therefore, with embodiments of the present disclosure, by transforming the third-party identifier to the proprietary account, the smart device may be accessed through the third-party login, reducing a usage threshold of the user.

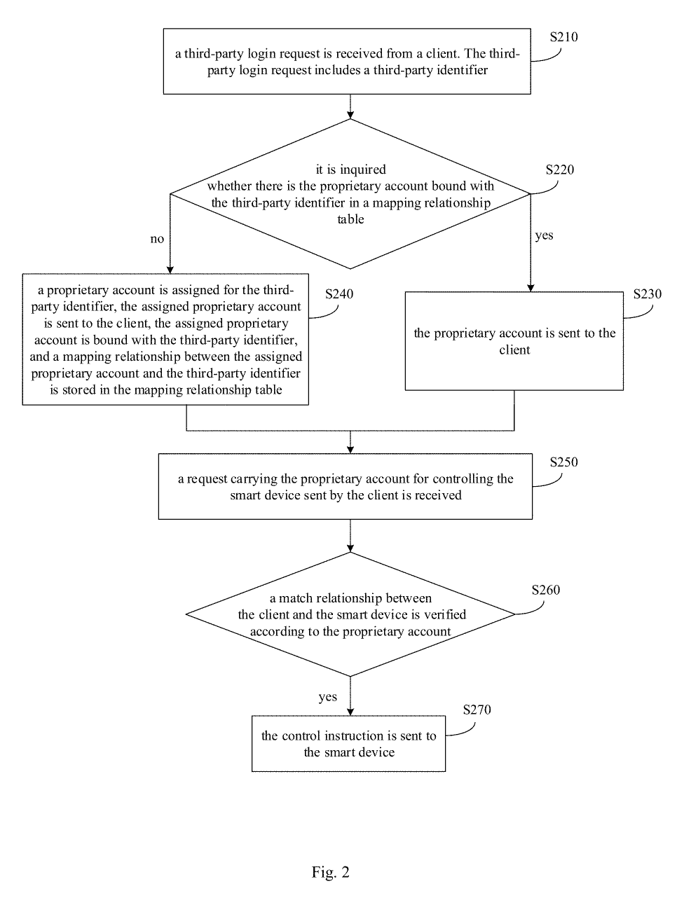

FIG. 2 is a flow chart of a method for controlling a smart device according to an embodiment of the present disclosure. This embodiment is further optimized on the basis of the above embodiment.

As illustrated in FIG. 2, the method for controlling the smart device according to this embodiment includes follows.

At block 210, a third-party login request is received from a client. The third-party login request includes a third-party identifier.

At block 220, it is inquired whether there is the proprietary account bound with the third-party identifier in a mapping relationship table. The mapping relationship table stores a mapping relationship between third-party identifiers and proprietary accounts.

When there is the proprietary account bound with the third-party identifier in the mapping relationship table, an act at block S230 is performed, and then an act at block at S250 is performed. Otherwise, an act at block S240 is performed, and then an act at block at S250 is performed.

At block S230, the proprietary account is sent to the client.

At block S240, a proprietary account is assigned for the third-party identifier, the assigned proprietary account is sent to the client, the assigned proprietary account is bound with the third-party identifier, and a mapping relationship between the assigned proprietary account and the third-party identifier is stored in the mapping relationship table.

It should be noted that, if the user logs in with a third-party account for the first time, the client may first obtain the third-party identifier sent from the third-party server, and then the client may sent the third-party login request to the smart device server. Since the third-party identifier is used to login for the first time, the smart device server cannot inquire a proprietary account bound with the third-party identifier, thus the smart device server may assign a proprietary account for the third-party identifier, and the assigned proprietary account is bound with the third-party identifier, the mapping relationship between the assigned proprietary account and the third-party identifier is stored in the mapping relationship table. When the user used the third-party identifier to login again, the smart device server may inquire the proprietary account bound with the third-party identifier, and then the smart device server sends the proprietary account to the client, such that the client accesses and controls the smart device via the smart device server based on the proprietary account.

At block S250, a request carrying the proprietary account for controlling the smart device sent by the client is received.

At block S260, a match relationship between the client and the smart device is verified according to the proprietary account.

If the match relationship between the client and the smart device is successfully verified, an act at block S270 is performed.

At block S270, the control instruction is sent to the smart device.

It should be noted that, after the third-party identifier is transformed to the proprietary account, the client accesses and controls the smart device though the smart device server under the proprietary account system of the smart device. If the client and the smart device have been paired according to the proprietary account, a pair relationship may be stored in the smart device server. The smart device server may verify the pair relationship. For example, the smart device server may inquire whether there is a pair relationship between the proprietary account and a target smart device in a pair mapping relationship table. If the there is a pair relationship between the proprietary account and the target smart device in the pair mapping relationship table, the verification is successful, a corresponding control instruction of the user is sent to the smart device. Otherwise, the proprietary account is not paired with the target smart device, and the proprietary account is not allowed to access the target smart device. At this time, prompt information may be returned to the client, such that the user may be guided to complete the pairing.

With embodiments of the present disclosure, by inquiring the mapping relationship table to obtain the proprietary account bound with the third-party identifier, or by assigning the proprietary account for the third-party identifier, binding the assigned proprietary account with the third-party identifier, and storing the mapping relationship between the assigned proprietary account and the third-party identifier in the mapping relationship table, the third-party identifier may be transformed to the proprietary account, completing the third-party login, realizing that the smart device is accessed through the third-party login, reducing a usage threshold of the user. In addition, in this process, the smart device is not necessary to sense existence of the third-party account, thus user data of the smart device may not be leaked to the third-party, ensuring safety of the user data.

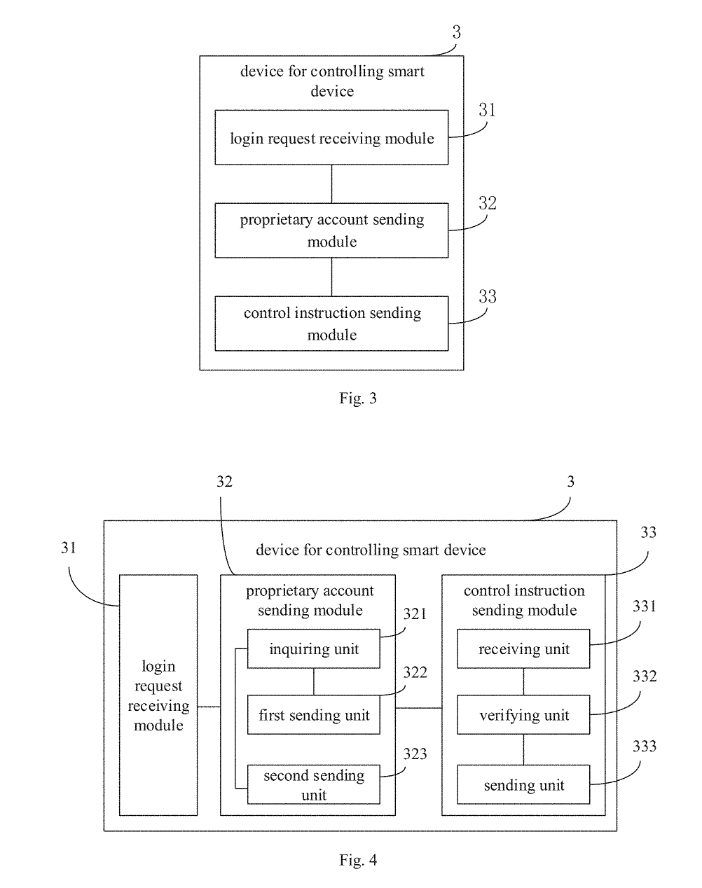

FIG. 3 is a block diagram illustrating a device for controlling a smart device according to an embodiment of the present disclosure. As illustrated in FIG. 3, the device 3 for controlling the smart device includes: a login request receiving module 31, a proprietary account sending module 32, and a control instruction sending module 33.

The login request receiving module 31 is configured to receive a third-party login request from a client. The third-party login request includes a third-party identifier.

The proprietary account sending module 32 is configured to obtain a proprietary account bound with the third-party identifier, and to send the proprietary account to the client.

The control instruction sending module 33 is configured to send a control instruction to the smart device according to the proprietary account in response to a request carrying the proprietary account for controlling the smart device sent by the client.

With embodiments of the present disclosure, when the client initiates the third-party login request, the proprietary account bound with the third-party identifier containing in the third-party login request is returned to the client. When the client initiates the request for controlling the smart device, the request for controlling the smart device may carry the proprietary account, such that the smart device server may complete the control to the smart device through the client according to the proprietary account. Therefore, with embodiments of the present disclosure, by transforming the third-party identifier to the proprietary account, the smart device may be accessed through the third-party login, reducing a usage threshold of the user.

FIG. 4 is a block diagram illustrating a device for controlling a smart device according to an embodiment of the present disclosure. This embodiment is further optimized on the basis of the above embodiment, in which same modules as those in the above embodiment adopt corresponding reference numerals, and details are not described herein again.

As illustrated in FIG. 4, the proprietary account sending module 32 includes an inquiring unit 321, a first sending unit 322, and a second sending unit 323.

The inquiring unit 321 is configured to inquire whether there is the proprietary account bound with the third-party identifier in a mapping relationship table. The mapping relationship table stores a mapping relationship between third-party identifiers and proprietary accounts.

The first sending unit 322 is configured to send the proprietary account to the client when there is the proprietary account bound with the third-party identifier in the mapping relationship table.

The second sending unit 323 is configured to, when there is no proprietary account bound with the third-party identifier in the mapping relationship table, assign a proprietary account for the third-party identifier, to send the assigned proprietary account to the client, to bind the assigned proprietary account with the third-party identifier and to store a mapping relationship between the assigned proprietary account and the third-party identifier in the mapping relationship table.

Further, the control instruction sending module 33 includes a receiving unit 331, a verifying unit 332 and a sending unit 333.

The receiving unit 331 is configured to receive the request carrying the proprietary account for controlling the smart device sent by the client.

The verifying unit 332 is configured to verify a match relationship between the client and the smart device according to the proprietary account.

The sending unit 333 is configured to, when the match relationship between the client and the smart device is successfully verified, send the control instruction to the smart device.

Further, the third-party identifier is a successfully verified third-party identifier sent from a third-party server to the client before the third-party login request from a client is received.

The device for controlling the smart device provided by the embodiments of the present disclosure may execute the method for controlling the smart device provided by any embodiment of the present disclosure and has corresponding functional modules performing the method and beneficial effects of the method.

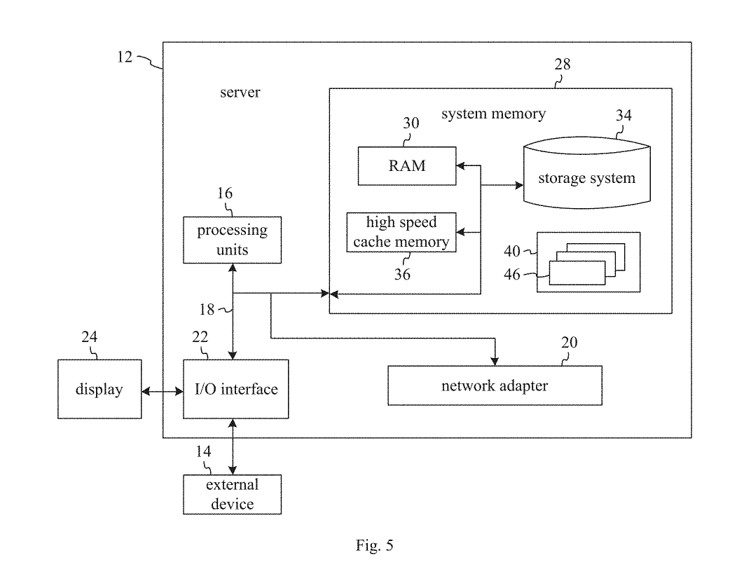

FIG. 5 is a schematic diagram illustrating a server according to an embodiment of the present disclosure. FIG. 5 illustrates a block diagram of an exemplary server 12 suitable for realizing implementations of the present disclosure. The server 12 illustrated in FIG. 5 is merely an example, which should be not understood to limit the functions and usage scope of embodiments of the present disclosure.

As illustrated in FIG. 5, the server 12 may be represented via a general computer device form. Components of the server 12 may include but be not limited to one or more processors or processing units 16, a system memory 28, and a bus 18 connecting various system components including the system memory 28 and the processing units 16.

The bus 18 represents one or more of several types of bus structures, including a memory bus or a memory controller, a peripheral bus, a graphics acceleration port, a processor, or a local bus using any of a variety of bus structures. For example, these architectures include, but are not limited to, an Industry Standard Architecture (hereinafter referred to as ISA) bus, a Micro Channel Architecture (hereinafter referred to as MAC) bus, an enhanced ISA bus, a Video Electronics Standards Association (hereinafter referred to as VESA) local bus and a Peripheral Component Interconnection (PCI) bus.

The server 12 typically includes a variety of computer system readable media. These media may be any available media accessible by the server 12 and includes both volatile and non-volatile media, removable and non-removable media.

The system memory 28 may include a computer system readable medium in the form of volatile memory, such as a random access memory (hereinafter referred to as RAM) 30 and/or a high speed cache memory 36. The server 12 may further include other removable or non-removable, volatile or non-volatile computer system storage media. By way of example only, the storage system 34 may be configured to read and write a non-removable and non-volatile magnetic media (not shown in FIG. 5, commonly referred to as a “hard drive”). Although not shown in FIG. 5, a magnetic disk driver for reading from and writing to a removable and non-volatile magnetic disk (such as “floppy disk”) and a disk driver for a removable and non-volatile optical disk (such as compact disk read only memory (hereinafter referred to as CD-ROM), Digital Video Disc Read Only Memory (hereinafter referred to as DVD-ROM) or other optical media) may be provided. In these cases, each driver may be connected to the bus 18 via one or more data medium interfaces. The memory 28 may include at least one program product. The program product has a set (such as, at least one) of program modules configured to perform the functions of various embodiments of the present disclosure.

A program/utility 40 having a set (at least one) of the program modules 46 may be stored in, for example, the memory 28. The program modules 46 include but are not limited to, an operating system, one or more application programs, other programs modules, and program data. Each of these examples, or some combination thereof, may include an implementation of a network environment. The program modules 46 generally perform the functions and/or methods in the embodiments described herein.

The server 12 may also communicate with one or more external devices 14 (such as, a keyboard, a pointing device, a display 24, etc.). Furthermore, the server 12 may also communicate with one or more communication devices enabling a user to interact with the server 12 and/or other devices (such as a network card, modem, etc.) enabling the server 12 to communicate with one or more computer devices. This communication can be performed via the input/output (I/O) interface 22. Also, the server 12 may communicate with one or more networks (such as a local area network (hereafter referred to as LAN), a wide area network (hereafter referred to as WAN) and/or a public network such as an Internet) through a network adapter 20. As shown in FIG. 6, the network adapter 20 communicates with other modules of the server 12 over the bus 18. It should be understood that, although not shown in FIG. 6, other hardware and/or software modules may be used in connection with the server 12. The hardware and/or software includes, but is not limited to, microcode, device drivers, redundant processing units, external disk drive arrays, RAID systems, tap Drive and data backup storage system.

The processing unit 16 is configured to execute various functional applications and data processing by running programs stored in the system memory 28, for example, implementing the method for controlling a smart device provided in embodiments of the present disclosure.

Embodiments of the present disclosure further provide a storage medium including computer executable instructions. When the computer executable instructions are executed by a computer processor, a method for controlling a smart device provided in embodiments of the present disclosure is executed. The method includes: receiving a third-party login request from a client, in which the third-party login request includes a third-party identifier; obtaining a proprietary account bound with the third-party identifier, and sending the proprietary account to the client; and sending a control instruction to the smart device according to the proprietary account in response to a request carrying the proprietary account for controlling the smart device sent by the client.

Embodiments of the present disclosure further provide a computer readable storage medium, storing computer programs thereon. When the computer programs are executed by a processor, the above-mentioned method for controlling a smart device is performed.

The storage medium provided by embodiments of the present disclosure may adopt any combination of one or more computer readable media. The computer readable medium may be a computer readable signal medium or a computer readable storage medium. The computer readable storage medium may be, but is not limited to, for example, an electrical, magnetic, optical, electromagnetic, infrared, or semiconductor system, apparatus, device, component or any combination thereof. A specific example of the computer readable storage media include (a non-exhaustive list): an electrical connection having one or more wires, a portable computer disk, a hard disk, a random access memory (RAM), a read only memory (ROM), an Erasable Programmable Read Only Memory (EPROM) or a flash memory, an optical fiber, a compact disc read-only memory (CD-ROM), an optical memory component, a magnetic memory component, or any suitable combination thereof. In context, the computer readable storage medium may be any tangible medium including or storing programs. The programs may be used by an instruction executed system, apparatus or device, or a connection thereof.

The computer readable signal medium may include a data signal propagating in baseband or as part of a carrier which carries computer readable program codes. Such propagated data signal may be in many forms, including but not limited to an electromagnetic signal, an optical signal, or any suitable combination thereof. The computer readable signal medium may also be any computer readable medium other than the computer readable storage medium, which may send, propagate, or transport programs used by an instruction executed system, apparatus or device, or a connection thereof.

The program code stored on the computer readable medium may be transmitted using any appropriate medium, including but not limited to wireless, wireline, optical fiber cable, RF, or any suitable combination thereof.

The computer program code for carrying out operations of embodiments of the present disclosure may be written in one or more programming languages. The programming language includes an object oriented programming language, such as Java, Smalltalk, C++, as well as conventional procedural programming language, such as “C” language or similar programming language. The program code may be executed entirely on a user's computer, partly on the user's computer, as a separate software package, partly on the user's computer, partly on a remote computer, or entirely on the remote computer or server. In a case of the remote computer, the remote computer may be connected to the user's computer or an external computer (such as using an Internet service provider to connect over the Internet) through any kind of network, including a Local Area Network (hereafter referred as to LAN) or a Wide Area Network (hereafter referred as to WAN).

It should be noted that, the above are only preferred embodiments and applied technical principles of the present disclosure. Those skilled in the art should understand that, the present disclosure is not limited to the specific embodiments described herein, and various obvious changes, readjustments and substitutions that are made by those skilled in the art will not depart from the scope of the present disclosure. Therefore, although the present disclosure has been described in detail by the above embodiments, the present disclosure is not limited to the above embodiments, and more other equivalent embodiments may be included without departing from the concept of the present disclosure, and the scope of the present disclosure is determined by the scope of the appended claims.

What is claimed is:

1. A method for controlling a smart device, comprising:
receiving a third-party login request from a client, wherein the third-party login request comprises a third-party identifier;
obtaining a proprietary account bound with the third-party identifier, and sending the proprietary account to the client; and
sending a control instruction to the smart device according to the proprietary account in response to a request carrying the proprietary account for controlling the smart device sent by the client.

2. The method according to claim 1, wherein obtaining the proprietary account bound with the third-party identifier and sending the proprietary account to the client comprises:
inquiring whether there is the proprietary account bound with the third-party identifier in a mapping relationship table, wherein the mapping relationship table stores a mapping relationship between third-party identifiers and proprietary accounts;
when there is the proprietary account bound with the third-party identifier in the mapping relationship table, sending the proprietary account to the client;
when there is no proprietary account bound with the third-party identifier in the mapping relationship table, assigning a proprietary account for the third-party identifier, sending the assigned proprietary account to the client, and binding the assigned proprietary account with the third-party identifier and storing a mapping relationship between the assigned proprietary account and the third-party identifier in the mapping relationship table.

3. The method according to claim 2, wherein sending the control instruction to the smart device according to the proprietary account in response to the request carrying the proprietary account for controlling the smart device sent by the client comprises:
receiving the request carrying the proprietary account for controlling the smart device sent by the client;
verifying a match relationship between the client and the smart device according to the proprietary account; and
when the match relationship between the client and the smart device is successfully verified, sending the control instruction to the smart device.

4. The method according to claim 1, wherein the third-party identifier is a successfully verified third-party identifier sent from a third-party server to the client before the third-party login request sent from the client is received.

5. The method according to claim 1, wherein the proprietary account belongs to an account system of the smart device.

6. A server, comprising:
one or more processors;
a storage device, configured to store one or more programs, wherein
the one or more processors are configured to read the one or more programs stored in the storage device to perform acts of:
receiving a third-party login request from a client, wherein the third-party login request comprises a third-party identifier;
obtaining a proprietary account bound with the third-party identifier, and sending the proprietary account to the client; and
sending a control instruction to the smart device according to the proprietary account in response to a request carrying the proprietary account for controlling the smart device sent by the client.

7. The server according to claim 6, wherein the one or more processors are configured to obtain the proprietary account bound with the third-party identifier and to send the proprietary account to the client by acts of:
inquiring whether there is the proprietary account bound with the third-party identifier in a mapping relationship table, wherein the mapping relationship table stores a mapping relationship between third-party identifiers and proprietary accounts;
when there is the proprietary account bound with the third-party identifier in the mapping relationship table, sending the proprietary account to the client;
when there is no proprietary account bound with the third-party identifier in the mapping relationship table, assigning a proprietary account for the third-party identifier, sending the assigned proprietary account to the client, and binding the assigned proprietary account with the third-party identifier and storing a mapping relationship between the assigned proprietary account and the third-party identifier in the mapping relationship table.

8. The server according to claim 7, wherein the one or more processors are configured to send the control instruction to the smart device according to the proprietary account in response to the request carrying the proprietary account for controlling the smart device sent by the client, by acts of:
receiving the request carrying the proprietary account for controlling the smart device sent by the client;
verifying a match relationship between the client and the smart device according to the proprietary account; and
when the match relationship between the client and the smart device is successfully verified, sending the control instruction to the smart device.

9. The server according to claim 6, wherein the third-party identifier is a successfully verified third-party identifier sent from a third-party server to the client before the third-party login request sent from the client is received.

10. The server according to claim 6, wherein the proprietary account belongs to an account system of the smart device.

11. A non-transitory computer readable storage medium, storing computer programs thereon, wherein when the computer programs are executed by a processor, a method for controlling a smart device is performed, the method comprising:
receiving a third-party login request from a client, wherein the third-party login request comprises a third-party identifier;
obtaining a proprietary account bound with the third-party identifier, and sending the proprietary account to the client; and
sending a control instruction to the smart device according to the proprietary account in response to a request carrying the proprietary account for controlling the smart device sent by the client.

12. The non-transitory computer readable storage medium according to claim 11, wherein obtaining the proprietary account bound with the third-party identifier and sending the proprietary account to the client comprises:
inquiring whether there is the proprietary account bound with the third-party identifier in a mapping relationship table, wherein the mapping relationship table stores a mapping relationship between third-party identifiers and proprietary accounts;
when there is the proprietary account bound with the third-party identifier in the mapping relationship table, sending the proprietary account to the client;
when there is no proprietary account bound with the third-party identifier in the mapping relationship table, assigning a proprietary account for the third-party identifier, sending the assigned proprietary account to the client, and binding the assigned proprietary account with the third-party identifier and storing a mapping relationship between the assigned proprietary account and the third-party identifier in the mapping relationship table.

13. The non-transitory computer readable storage medium according to claim 12, wherein sending the control instruction to the smart device according to the proprietary account in response to the request carrying the proprietary account for controlling the smart device sent by the client comprises:
receiving the request carrying the proprietary account for controlling the smart device sent by the client;
verifying a match relationship between the client and the smart device according to the proprietary account; and
when the match relationship between the client and the smart device is successfully verified, sending the control instruction to the smart device.

14. The non-transitory computer readable storage medium according to claim 11, wherein the third-party identifier is a successfully verified third-party identifier sent from a third-party server to the client before the third-party login request sent from the client is received.

15. The non-transitory computer readable storage medium according to claim 11, wherein the proprietary account belongs to an account system of the smart device.
